(19) United States
(12) Patent Application Publication
(10) Pub. No.: US 2006/0089176 A1
(43) Pub. Date: Apr. 27, 2006

(54) Acoustic device for vehicle

(75) Inventor: Katsuyoshi Oki, Daito-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., OSAKA 570-8677 (JP)

(21) Appl. No.: 10/549,580

(22) PCT Filed: Aug. 23, 2004
(86) PCT No.: PCT/JP04/12048

§ 371 Date: Sep. 19, 2005

(30) Foreign Application Priority Data
Sep. 17, 2003 (JP) 2003-323983

(51) Int. Cl. H04M 1/00

(52) U.S. Cl. 455/569.1

(57) ABSTRACT

The vehicle-mounted acoustic apparatus of the present invention can be connected to a mobile phone 50; can receive hands-free conversations from the mobile phone 50 and radio broadcasts; and provides a microphone 3 for collecting the sounds of a user, and a speaker 2 for producing the sounds of a radio broadcast or a conversing party. When operating a plurality of preset keys 9a-f that are used for selecting the frequency of radio broadcasts to be received, it is possible to select a phone number that has been stored in the mobile phone 50 or the vehicle-mounted acoustic apparatus, or input the numerals or symbols that constitute the phone number.

### TECHNICAL FIELD

The present invention relates to vehicle-mounted acoustic apparatuses provided with a hands-free function for mobile phones.

### BACKGROUND ART

With mobile phones such as cellular phones coming into common use in recent years, the use of mobile phones in vehicles has been rapidly increasing. However, since the use of mobile phones in vehicles detracts from the driver's attention, this has become one cause of traffic accidents. Thus, vehicle-mounted hands-free devices have become widely used in order to reduce the amount of concentration required for conversing while driving.

Ordinary vehicle-mounted hands-free devices are provided with a speaker, a microphone and a hands-free unit that includes, for example, a micro-computer and an audio codec portion for control. The driver can converse with the person on the other end of the phone using the mobile phone without taking his hands from the wheel by listening to the voice of the other person generated by the speaker, and by speaking into the microphone.

In some types of vehicle-mounted hands-free devices, the hands-free unit and the mobile phone may be connected through a short-range wireless connection, using wireless communicating means based on Bluetooth, or the like, so as to eliminate the complexity of connecting the hands-free unit to the mobile phone. With such a configuration, it is possible to have a hands-free conversation without connecting the mobile phone to the hands-free unit by a cable. For example, it is possible to have a hands-free conversation while the mobile phone is still contained in its case.

Patent Document 1: JP 2002-290538A

### DISCLOSURE OF INVENTION

Problem that the Invention Attempts to Solve

However, conventional vehicle-mounted hands-free devices have not been provided with sufficient operating functions, and when making a call, the driver has had to operate a keypad to input the phone number of the person with whom he wishes to speak. Thus, even though a hands-free device is being used, a condition is created in which the driver is driving with one hand, or is not fully concentrating on driving, and thus the safety of the driver while driving has not been sufficiently maintained.

Furthermore, in order to provide the vehicle-mounted hands-free device in the vehicle, free space for installing the hands-free unit has been required. It has also been necessary to prepare holding members for holding the hands-free unit, and to do work to attach such holding members to the chassis.

The present invention has been invented to solve the above-noted problems, and it provides sufficient operational functions necessary for making calls, does not require space or holding members for attachment inside the vehicle, and provides hands-free conversing means for a mobile phone.

Means for Solving the Problem

The vehicle-mounted acoustic apparatus of the present invention provides a vehicle-mounted acoustic apparatus that can be connected to a mobile phone; which can receive hands-free conversations from the mobile phone and radio broadcasts; and which comprises a microphone for collecting the sounds of a user, and a, speaker for producing the sounds of a radio broadcast or a conversing party, wherein a phone number that is stored in the mobile phone or the vehicle-mounted acoustic apparatus is selected using a plurality of preset keys that are used for selecting the frequency of radio broadcasts to be received.

The vehicle-mounted acoustic apparatus of the present invention also provides a vehicle-mounted acoustic apparatus that can be connected to a mobile phone; which can receive hands-free conversations from the mobile phone and radio broadcasts; and which comprises a microphone for collecting the sounds of a user, and a speaker for producing the sounds of a radio broadcast or a conversing party, wherein numerals or symbols that constitute a phone number are input using a plurality of preset keys that are used for selecting the frequency of radio broadcasts to be received.

The vehicle-mounted acoustic apparatus of the present invention provides a vehicle-mounted acoustic apparatus that can be connected to a mobile phone; which can receive hands-free conversations from the mobile phone and radio broadcasts; and which comprises a microphone for collecting sounds of a user, and a speaker for producing the sounds of a radio broadcast or a conversing party, wherein each of a plurality of preset keys that are used for selecting the frequency of radio broadcasts to be received are associated with a display pattern that corresponds to an upper portion or a lower portion of a shape by which the numerals from 0 to 9 are displayed, and wherein using the plurality of preset keys, the numerals that constitute a phone number are input by entering the upper portion or lower portion of the form by which the numerals are displayed.

Effect of the Invention

Since the vehicle-mounted acoustic apparatus has a function for conversing hands-free on a mobile phone, in order to converse hands-free, it is not necessary to provide free space within a vehicle to install the hands-free unit, and thus the space within the vehicle can be used efficiently. Thus, no holding members are required for holding the hands-free unit, and there is also no requirement to do work on the interior of the vehicle in order to have a hands-free conversation.

Moreover, since the vehicle-mounted acoustic apparatus is able to provide a hands-free conversation, operating means provided by the vehicle-mounted acoustic apparatus may be used as the operating means when making a call. Thus, operations relating to hands-free conversation are made easier than with conventional vehicle-mounted hands-free apparatuses, and a wider range of actions may be ordered through those operations. As described above, in the present invention, a phone number of a conversation partner may be selected, or input, and the call initiated by using the preset keys that are provided by the vehicle-mounted acoustic apparatus. Thus, calls may be made using the vehicle-mounted acoustic apparatus without providing a key pad for entering phone numbers, and it is possible to suppress the increase in cost usually created by the provision of a hands-free function.

Furthermore, in the present invention, the preset keys provided by the vehicle-mounted acoustic apparatus are used for selecting or inputting the phone number of the conversation partner, and they are shared with the operating system used for making calls, and the operating system that is used for receiving radio broadcasts. Thus, the operations performed when making a call are similar to the operations performed when receiving radio broadcasts, and thus they are easy for the user to understand and remember.

### BRIEF DESCRIPTION OF DRAWINGS

FIG. 1 is a front view of a main unit of a vehicle-mounted acoustic apparatus, which is an embodiment of the present invention.

FIG. 2 is a block diagram showing a configuration of the vehicle-mounted acoustic apparatus, which is an embodiment of the present invention.

FIG. 3 is a block diagram showing a configuration of a mobile phone.

FIG. 4 is an explanatory diagram showing the transmission of the conditions of the vehicle-mounted acoustic apparatus, which is an embodiment of the present invention.

FIG. 5 is an explanatory diagram showing the stored content of the phone number directory memory of the mobile phone.

FIG. 6 is a front view of preset keys provided on the vehicle-mounted acoustic apparatus, which is an embodiment of the present invention.

FIG. 7 is a table showing numbers and symbols that are input by either a single click or a double click of the preset keys provided on the vehicle-mounted acoustic apparatus, which is an embodiment of the present invention.

FIG. 8 is a flowchart showing operations performed by a control portion of the vehicle-mounted acoustic apparatus, which is an embodiment of the present invention, when in normal dial mode.

FIG. 9 is a flowchart showing a timer interrupt process that is performed by a control portion of the vehicle-mounted acoustic apparatus, which is an embodiment of the present invention.

FIG. 10 is an explanatory diagram of a segment group provided on a display portion of the vehicle-mounted acoustic apparatus, which is an embodiment of the present invention.

FIG. 11 is a table showing the form by which the numbers “0” to “9” are displayed in the segment group, and the upper portion and the lower portion of the numbers.

FIG. 12 is a front view of the preset keys provide by the vehicle-mounted acoustic apparatus, which is a second embodiment of the present invention.

FIG. 13 is a table showing a combination of the preset keys provided by the vehicle-mounted acoustic apparatus, which is a second embodiment of the present invention, the preset keys being pressed when entering the numerals from “0” to “9”.

FIG. 14 is a flowchart showing operations performed by a control portion of the vehicle-mounted acoustic apparatus, which is a second embodiment of the present invention, when in normal dial mode.

FIG. 15 is a flowchart showing operations performed by the control portion of the vehicle-mounted acoustic apparatus, which is the second embodiment of the present invention, when in normal dial mode.

FIG. 16 is a flowchart showing operations performed by the control portion of the vehicle-mounted acoustic apparatus, which is the second embodiment of the present invention, when in normal dial mode.

FIG. 17 is a flowchart showing operations performed by the control portion of the vehicle-mounted acoustic apparatus, which is the second embodiment of the present invention, when in normal dial mode.

FIG. 18 is a flowchart showing operations performed by the control portion of the vehicle-mounted acoustic apparatus, which is the second embodiment of the present invention, when in normal dial mode.

FIG. 19 is a flowchart showing operations performed by the control portion of the vehicle-mounted acoustic apparatus, which is the second embodiment of the present invention, when in normal dial mode.

FIG. 20 is a flowchart showing operations performed by the control portion of the vehicle-mounted acoustic apparatus, which is the second embodiment of the present invention, when in normal dial mode.

### DESCRIPTION OF SYMBOLS

1 vehicle-mounted acoustic apparatus

2 speaker

3 microphone

9a-f preset keys

50 mobile phone

### BEST MODE FOR CARRYING OUT THE INVENTION

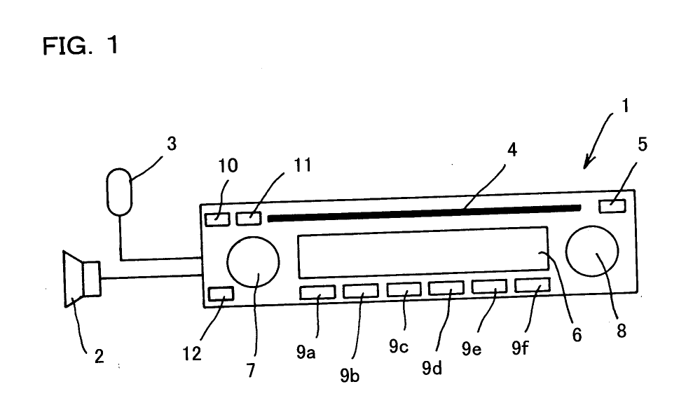

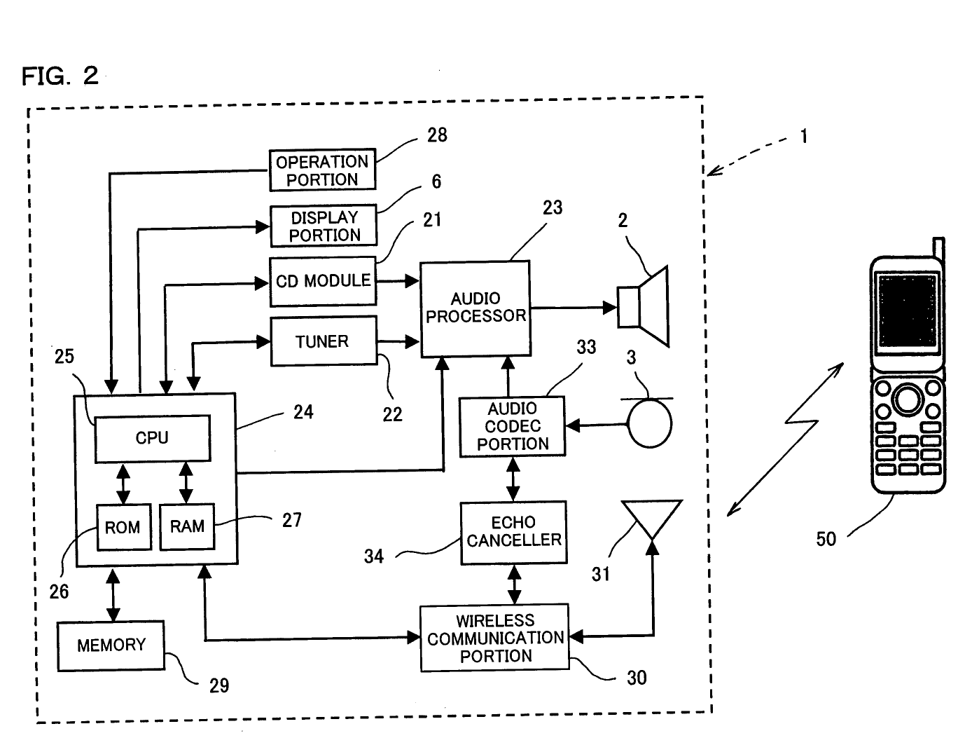

The present invention is described below using the drawings. FIG. 1 is a front view of a main unit of a vehicle-mounted acoustic apparatus 1, which is an embodiment of the present invention. In a similar manner to ordinary vehicle-mounted acoustic apparatuses, the main unit of the vehicle-mounted acoustic apparatus 1 is mounted on the console of the center panel of the vehicle. The vehicle-mounted acoustic apparatus 1 is provided with a radio broadcast receiving function, and is further provided with a function for reproducing a disk-shaped recording medium (hereafter referred to as a “disk”), such as a CD-DA or CD-R/RW. The main unit of the vehicle-mounted acoustic apparatus 1 is connected to a plurality of speakers 2 for outputting the sound of the radio broadcasts received, or the sound of reproduced disks. FIG. 1 (and FIG. 2) shows only a single speaker 2, however the main unit of the vehicle-mounted acoustic apparatus 1 may be connected to a plurality of speakers installed inside the doors and at the rear of the vehicle cabin in the same manner as general vehicle-mounted acoustic apparatuses. The vehicle-mounted acoustic apparatus 1 has a function for conversing hands-free with a mobile phone, as will be described below, and the speakers 2 output the sound of the party with whom the hands-free conversation is occurring. The main unit of the vehicle-mounted acoustic apparatus 1 is connected to a microphone 3, in addition to the speakers 2, and the microphone 3 is installed, for example, on the center panel of the vehicle. The microphone collects the sounds generated by the party, such as the driver, who is having the hands-free conversation (hereafter referred to as the “user”) and converts them to an electric signal.

The front surface of the main unit of the vehicle-mounted acoustic apparatus 1 is provided with a disk insertion aperture 4 through which disks are inserted or ejected. An eject key 5 for directing the ejection of the inserted disk is arranged on the right side of the disk insertion aperture 4. A display portion 6 that displays various kinds of information is arranged below the disk insertion aperture 4. The display portion 6 may utilize, for example, a liquid crystal display device (LCD), and information, such as the frequency of the radio broadcast that is being received, or the track number stored on the disk of the music that is being reproduced, may be displayed. A volume knob 7 and a tuning knob 8 are provided on the sides of the display portion 6 respectively. The volume knob 7 is a knob with a push switch attached, so that the volume generated by the speakers 2 may be adjusted by rotating the volume knob 7, and the power of the vehicle-mounted acoustic apparatus 1 may be turned on or off by pushing the volume knob 7. Rotating the tuning knob 8 continuously changes the frequency of the radio broadcast that is received by the vehicle-mounted acoustic apparatus 1.

Six preset keys 9a-f constituted by a first preset key 9a to a sixth preset key 9f are arranged in a line from left to right below the display portion 6. The preset keys 9a-f are used for selecting the radio broadcast that the vehicle-mounted acoustic apparatus 1 receives, in the same manner as an ordinary vehicle-mounted acoustic apparatus. The radio frequency of the broadcasts is stored to correspond to the preset keys 9a-f, and when any of the preset keys 9a-f are pressed, the frequency of the vehicle-mounted acoustic apparatus 1 is matched to the frequency corresponding to the preset key 9a-f that was pressed. These preset keys 9a-f are also used to select the number of the track when reproducing a disk, specify the replay mode, such as repeat or random, or to specify operations such as FF or REW. Further, these preset keys 9a-f are also used when conversing hands-free using the mobile phone, as is described later.

An audio mode switching key 10 and a hands-free key 11 are arranged on the left side of the disk insertion aperture 4. Each time the audio mode switching key 10 is pressed, the operating mode of the vehicle-mounted acoustic apparatus 1 switches between a radio broadcast receiving mode and a disk reproduction mode. When the hands-free key 11 is pressed while in these operating modes, the vehicle-mounted acoustic apparatus 1 changes to a state in which hands-free conversation using the mobile phone is possible (hereafter referred to as the “hands-free mode”). When the audio mode switching key 10 is pressed while in the hands-free mode, the hands-free mode is cancelled. A hands-free mode switching key 12 is arranged below and to the left of the volume knob 7, and is used to switch between various modes while in the hands-free mode.

FIG. 2 is a block diagram showing a configuration of the vehicle-mounted acoustic apparatus 1 of the present embodiment. FIG. 2 shows an overview of the vehicle-mounted acoustic apparatus 1, and constituent elements that are not directly related to the present invention are not illustrated. The vehicle-mounted acoustic apparatus 1 provides a CD module 21 for reproducing disks, and a tuner 22 for receiving radio broadcasts. Audio signals that are output from these are output to the speaker 2 via an audio processor 23 and an amplifier (not illustrated). The CD module 21, the tuner 22 and the audio processor 23 are connected to and controlled by a control portion 24 that controls and processes various operations of the vehicle-mounted acoustic apparatus 1. The control portion 24 uses a microcomputer provided with a CPU 25, a ROM 26 and a RAM 27. In addition to the display portion 6, the various keys and knobs such as the above-noted preset keys 9a-f, the hands-free key 11 and the volume knob 7 are also connected to the control portion 24. These are shown summarized in FIG. 2 as an operating portion 28. Furthermore, the control portion 24 is also connected to a phone number memory 29 that stores phone numbers.

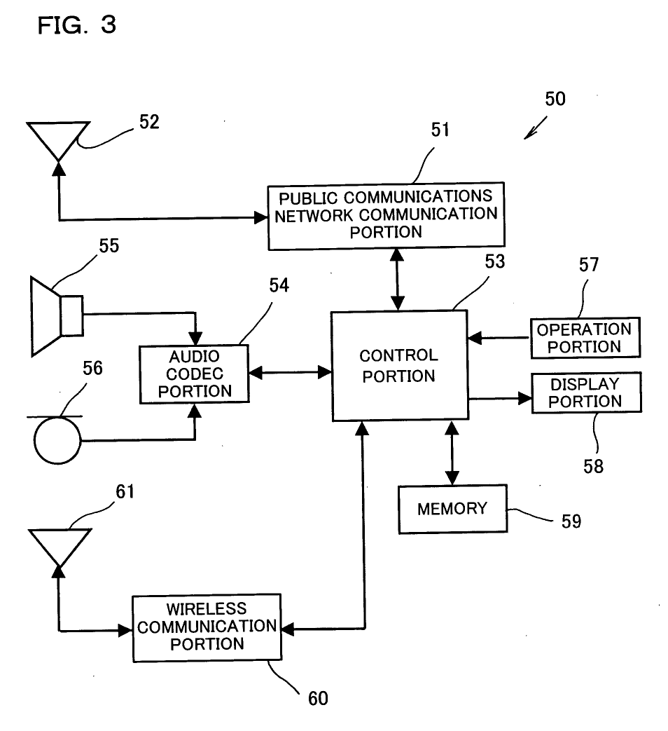

The vehicle-mounted acoustic apparatus 1 is capable of connecting to and communicating with the mobile phone 50 through a short-range wireless connection, and transmission of signals and data necessary for hands-free conversation is carried out between the vehicle-mounted acoustic apparatus 1 and the mobile phone 50 based on the short-range wireless connection. A portable phone or car phone, or the like, may be used as the mobile phone 50. FIG. 3 is a block diagram showing the configuration of the mobile phone 50. The mobile phone 50 is provided with a public communication network portion 51 for communicating with other phones via a wireless mobile communication network. The public communications network portion 51 is connected to an antenna 52, and, for example, demodulates signals received from the wireless mobile communications network via the antenna 52 and modulates signals transmitted to the wireless mobile communications network via the antenna 52.

A speaker 55 and a microphone 56 are connected to a control portion 53 via an audio codec portion 54. The audio codec portion 54 encodes the audio signal that is output from the microphone 56 and sends it to the control portion 53, and demodulates the signal that the public communications network communication portion 51 receives and outputs it to the speaker 55. The control portion 53 performs various controls and processes relating to the mobile phone 50. For example, a microcomputer can be used and in addition to the constituent components described above, an operation portion 57, such as a number pad or a display portion 58, or the like may be connected to the control portion 53. An LCD may be used as the display portion 58. Moreover, a phone number memory 59 for storing phone numbers may be connected to the control portion 53, and a desired phone number that is stored in the memory 59 may be selected and called by operating the operation portion 57 without entering the phone number with the number pad.

In the present embodiment, a short-range wireless connection is set up to connect the vehicle-mounted acoustic apparatus 1 to the mobile phone 50 using a wireless communication means based on, for example, the Bluetooth standard. As shown in FIG. 2 and FIG. 3, the vehicle-mounted acoustic apparatus 1 and the mobile phone 50 are provided with wireless communication portions 30 and 60, respectively. The wireless communication portions 30 and 60 are connected to antennas 31 and 61 respectively, for transmitting and receiving RF waves in a predetermined frequency band.

The wireless communication portions 30 and 60 are provided with a modulation/demodulation portion for modulating and demodulating the signals that are transmitted and received, a base band portion for managing a wireless communication link, and a link manager portion, for example (not shown) for controlling the state of the connection. The ROM 26 of the control portion 24 and the ROM of the control portion 53 (not shown) store a program in which communication data control processing according to Bluetooth protocol, or the like, is recorded, and the program is executed by the control portions 24 and 53.

Referring to FIG. 2, the microphone 3 of the vehicle-mounted acoustic apparatus 1 is connected to the wireless communication portion 30 via an audio codec portion 33 and an echo canceller 34. When conversing hands-free, the sound generated by the user is converted by the microphone 3 into a transmission audio signal, and the transmission audio signal is encoded by the audio codec portion 33. The echo canceller 34 produces a pseudo-echo that corresponds to the voice of the conversing party that is transmitted from the wireless communication portion 30, based on the received audio signal, and cancels the component of the pseudo-echo that is produced, from the transmission audio signal that is output from the audio codec portion 33. In this way, problems caused by an acoustic echo during the hands-free conversation are eliminated.

The transmission audio signal is transmitted from the echo canceller 34 to the wireless communications portion 30, after which it is transmitted from the wireless communication portion 30 to the wireless communication portion 60 of the mobile phone 50 by wireless communication. Then, the mobile phone 50 transmits the transmission audio signal to the wireless mobile communications network via the public communications network communication portion 51. The received audio signal is transmitted to the audio codec portion 33 of the vehicle-mounted acoustic apparatus 1 along the opposite route to the transmission audio signal, and is demodulated in the audio codec portion 33. The demodulated received audio signal is then transmitted from the audio codec portion 33 to the speaker 2 via the audio processor 23, and the sound of the conversing party is output from the speaker 2.

The operation of the vehicle-mounted acoustic apparatus 1 is described next in further detail. Because the hands-free conversation is carried out using the vehicle-mounted acoustic apparatus 1, the hands-free connection is established between the vehicle-mounted acoustic apparatus 1 and the mobile phone 50 using wireless communication means. A connection may be created wherein the vehicle-mounted acoustic apparatus 1 is the master and the mobile phone 50 is the slave, or where the mobile phone 50 is the master and the vehicle-mounted acoustic apparatus 1 is the slave (for the purpose of simplicity, the situation will be described below wherein the vehicle-mounted acoustic apparatus 1 is the master and the mobile phone 50 is the slave). First, in the state in which the power source of the vehicle-mounted acoustic apparatus 1 and the mobile phone 50 is on, the vehicle-mounted acoustic apparatus 1 searches the vicinity for a device to which it is capable of making a wireless connection. As a result of the search, the mobile phone 50 is listed up, and when an encryption key, such as a PIN (Personal Identification Number) Code, held by the mobile phone 50 is entered into the vehicle-mounted acoustic apparatus 1, the vehicle-mounted acoustic apparatus 1 sends a hands-free connection request to the mobile phone 50. The hands-free connection is established between the vehicle-mounted acoustic apparatus 1 and the mobile phone 50 when the mobile phone 50 replies to the connection request. For the second and future connections, the encryption key is not required to be entered, and the identification process is performed using a link key. The link key is created based on the encryption key that is entered during the first connection. The vehicle-mounted acoustic apparatus 1 periodically searches for devices capable of wireless connection, and the hands-free connection is established between the vehicle-mounted acoustic apparatus 1 and the mobile phone 50 when the mobile phone 50 is brought into the vehicle.

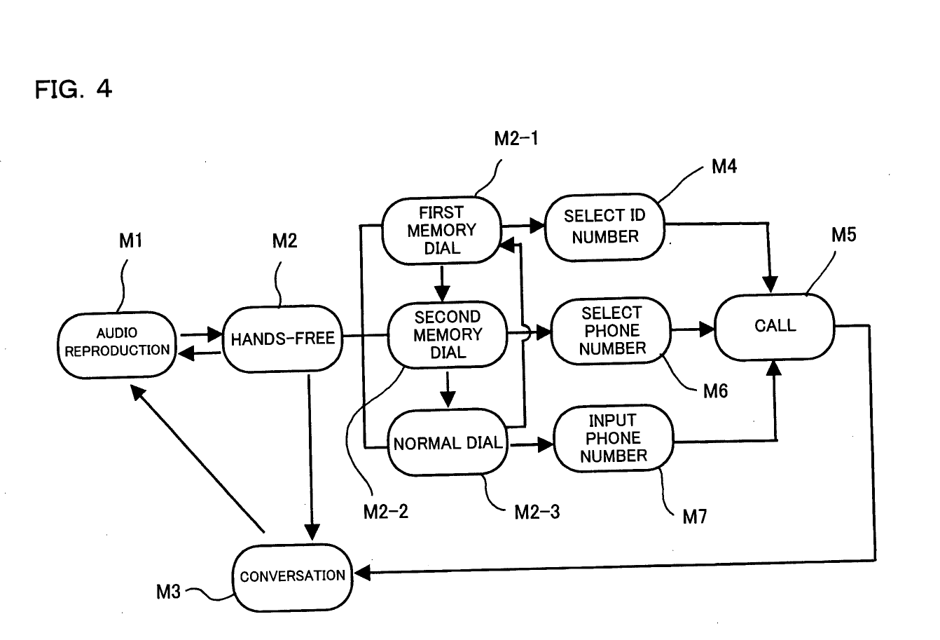

FIG. 4 is an explanatory diagram showing the transition of the states of the vehicle-mounted acoustic apparatus 1. If the hands-free key 11 is pressed while in an audio reproduction mode MI that is for receiving radio broadcasts or reproducing disks, then the vehicle-mounted acoustic apparatus 1 moves to a hands-free mode M2, in which hands-free conversing is possible, in addition to receiving radio broadcasts or reproducing disks. If the audio mode switching key 10 is pressed while in the hands-free mode M2, then the vehicle-mounted acoustic apparatus 1 moves from the hands-free mode M2 to the audio reproduction mode M1.

The vehicle-mounted acoustic apparatus 1 will move from the audio reproduction mode Ml to the hands-free mode M2 if a call-received notification is transmitted to the mobile phone 50 through the hands-free connection while in the audio reproduction mode M1. The control portion 24 controls the audio processor 23 so as to substitute the audio signal output from the wireless communication portion 30 for the audio signal that is output from the CD module 21 or the tuner 22. Then, the control portion 24 directs the audio processor 23 so as to output a sound through the speaker 2 to alert the user of an incoming call. If the user presses the hands-free key 11 when he hears the call sound, then an answer-call notification is transmitted from the vehicle-mounted acoustic apparatus 1 to the mobile phone 50 through the hands-free connection, and the vehicle-mounted acoustic apparatus 1 moves to a hands-free conversation mode M3.

When the answer-call notification transmitted from the vehicle-mounted acoustic apparatus 1 is received, the mobile phone 50 sends and receives audio signals between itself and the phone of the conversing party via the wireless mobile communications network. In the hands-free conversation mode M3, the received audio signal that is transmitted from the conversing party's phone via the wireless mobile communications network to the mobile phone 50 is transmitted from the mobile phone 50 to the vehicle-mounted acoustic apparatus 1 through the hands-free connection, and the sound of the conversing party is output from the speaker 2. Furthermore, the microphone 3 converts the voice of the user to a transmission audio signal, the transmission audio signal is transmitted from the vehicle-mounted acoustic apparatus 1 to the mobile phone 50 through the hands-free connection, and is further transmitted to the conversing party's phone through the wireless mobile communications network.

When a call-end notification is transmitted from the conversing party's phone to the mobile phone 50 and connection to the mobile phone 50 ends, a notification to the effect that the conversation is finished is sent from the mobile phone 50 to the vehicle-mounted acoustic apparatus 1, and the vehicle-mounted acoustic apparatus 1 moves from the hands-free conversation mode M3 to the audio reproduction mode Ml. Furthermore, if the user presses the hands-free key 11 while in the hands-free conversation mode M3, then the vehicle-mounted acoustic apparatus 1 moves to the audio reproduction mode M1 as well as directing the vehicle-mounted acoustic apparatus 1 to send a notification to the mobile phone 50 that the conversation has ended.

The user can also make a call with the mobile phone 50 using the vehicle-mounted acoustic apparatus 1 while in the hands-free mode M2. When in the hands-free mode M2, the vehicle-mounted acoustic apparatus 1 is in any one mode of three modes, namely a first memory dial mode M2-1 for using the mobile phone 50 to call a phone number that is stored in the memory 59 of the mobile phone 50, a second memory dial mode M2-2 for using the mobile phone 50 to call a phone number that is stored in the memory 29 of the vehicle-mounted acoustic apparatus 1, or a normal dial mode M2-3 for using the mobile phone 50 to call a phone number that is input by operating the preset keys 9a-f of the vehicle-mounted acoustic apparatus 1. One of these modes is selected in rotation whenever the hands-free mode switch key 12 is pressed and held. The display portion 6 displays the currently selected mode.

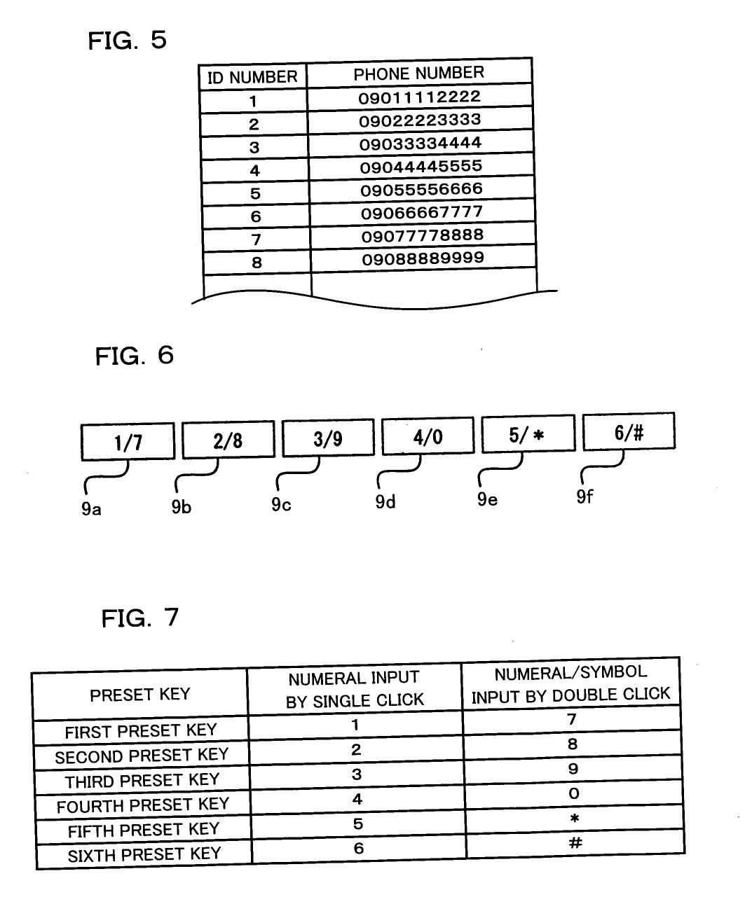

The first memory dial mode M2-1 is described first. In the first memory dial mode M2- 1, the preset keys 9a-f are used for selecting a phone number that is stored in the phone number memory 59 of the mobile phone 50. As shown in FIG. 5, a plurality of phone numbers and a unique ID number attached to each phone number is stored in the memory 59. When in the first memory dial mode M2-1, the preset keys 9a-f of the vehicle-mounted acoustic apparatus 1 are associated with the ID numbers stored in the memory 59 of the mobile phone 50. For example, the preset keys 9a-f are associated in the order of the ID numbers from the left side. More specifically, the first preset key 9a is associated with the ID number “1”, the second preset key 9b is associated with the ID number “2”, and the sixth preset key 9f is associated with the ID number “6”. The preset keys 9a-f are associated with the ID numbers such that they are not duplicated, and the preset keys 9a-f are associated with the ID numbers by, for example, recording the relationship in a program for processing input in the first memory dial mode M2-1, wherein the program is stored in the ROM 26.

In the first memory dial mode M2-1, when a given preset key 9a-f is pressed, the ID number corresponding to the preset key 9a-f that was pressed is selected, that is, the ID number to which the desired phone number is associated, is input into the vehicle-mounted acoustic apparatus 1 (M4). More specifically, the CPU 25 of the control portion 24 receives a signal transmitted from the preset key 9a-f that was pressed, and specifies the ID number that corresponds to the preset key 9a-f.

When the hands-free key 11 is pressed while in the ID number input mode M4, the vehicle-mounted acoustic apparatus 1 initiates a call, that is to say, the vehicle-mounted acoustic apparatus 1 performs an operation whereby a notification for directing a call to the phone number that is both stored in the phone number memory 59 and to which an associated ID number is specified in the CPU 25 is transmitted to the mobile phone 50 through the hands-free connection M5. The control portion 53 of the mobile phone 50 that receives the notification of the directive to call, reads out the phone number that corresponds to the ID number from the phone number memory 59, and calls that phone number. Then, when a call-connected notification is transmitted to the mobile phone 50 from the phone of the conversing party that corresponds to the phone number, and the mobile, phone 50 receives the call-connected notification, audio signals may be sent and received between the mobile phone 50 and the conversing party's phone via the wireless mobile communications network. When the vehicle-mounted acoustic apparatus 1 receives notification from the mobile phone 50 to the effect that the call-connected notification has been received, the vehicle-mounted acoustic apparatus 1 moves to the hands-free conversation mode M3.

In the second memory dial mode M2-2, the preset keys 9a-f are used to select phone numbers stored in the phone number memory 29 of the vehicle-mounted acoustic apparatus 1. A plurality of phone numbers, and ID numbers that are uniquely attached to the phone numbers, are stored in the memory 29 in the same manner as in the phone number memory 59 of the mobile phone 50 (as in FIG. 5). The procedure for storing the phone numbers in the memory 29 is described below.

While in the second memory dial mode M2-2, the preset keys 9a-f are associated with the ID numbers stored in the phone number memory 29 of the vehicle-mounted acoustic apparatus 1 as described above. For example, the preset keys 9a-f are associated with the ID numbers in order from the left side. The preset keys 9a-f are associated with the ID numbers by, for example, recording the relationship in a program for processing input in the second memory dial mode M2-2. This program is stored in the ROM 26.

Pressing a certain preset key 9a-f selects the phone number corresponding to the ID number that corresponds to the preset key 9a-f that was pressed. That is to say, the ID number corresponding to the desired phone number is entered into the vehicle-mounted acoustic apparatus 1 (M6). More specifically, when the CPU 25 of the control portion 24 receives the signal from the preset key 9a-f that was pressed, the CPU 25 specifies an ID number to correspond to the preset key 9a-f that was pressed. Then, the CPU 25 reads out the phone number corresponding to the specified ID number from the phone number memory 29. The control portion 24 directs the phone number that was read out to be displayed on the display portion 6.

When the hands-free key 11 is pressed while in a phone number selection mode M6, the vehicle-mounted acoustic apparatus 1 calls the number. That is to say, an action is performed to transmit a notification ordering a call to the phone number that was read out, to the mobile phone 50 via the hands-free connection (M5). Then, in a similar manner as the procedure described previously, the vehicle-mounted acoustic apparatus 1 moves to the hands-free conversation mode M3.

In the present embodiment, in all, six preset keys 9a-f are provided in the vehicle-mounted acoustic apparatus 1. The ID numbers corresponding to the preset keys 9a-f may be changed by pressing the hands-free mode switch key 12, for example, so as to increase the phone numbers that may be selected by the preset keys 9a-f in the first memory dial mode M2-1 and the second memory dial mode M2-2. For example, the first preset key 9a corresponds to the ID number “1”, however when the hands-free mode switch key 12 is pressed, it is configured to correspond to the ID number “7”.

The normal dial mode M2-3 is described next. The normal dial mode M2-3 differs from the two modes previously described in that the numerals or symbols that constitute the phone number of the conversing party are input by operating the preset keys 9a-f.

FIG. 6 is a front view of the preset keys 9a-f. In the vehicle-mounted acoustic apparatus 1 of the present embodiment, it is possible to input the numerals “0” to “9” operating the preset keys 9a-f, as well as the symbols “*” and “#”. Since the vehicle-mounted acoustic apparatus 1 provides a total of six preset keys 9a-f, in order to enter the total 12 numerals and symbols, the numerals or symbols that are input when the preset keys 9a-f of the vehicle-mounted acoustic apparatus 1 of the present embodiment are single clicked (one push) are different to those input when they are double clicked (two pushes).

Referring to FIG. 6, the group of numbers, or of numbers and symbols that are input by the preset keys 9a-f to the vehicle-mounted acoustic apparatus 1 are engraved on the preset keys 9a-f The numerals that are input with a single click are engraved on the left side of the “/” on the preset keys 9a-f, and the numerals or symbols that are input with a double click are engraved on the right side of the “/”. For example, when the first preset key 9a is single clicked, the numeral “1” is entered, and when the sixth preset key 9f is double clicked, the symbol “#” is entered. FIG. 7 is a table summarizing the numerals and symbols that are input by single clicking or double clicking the preset keys 9a-f.

When the preset keys 9a-f are single clicked or double clicked while in the normal dial mode M2-3, the numeral or symbol that is input is displayed on the display portion 6 in the order as entered from left to right. The position (input position) of the numerals or symbols that are entered can be changed by operating the tuning knob 8. If the tuning knob 8 is rotated one step to the right, then the input position moves to the next position (to the right on the display portion 6), and when the tuning knob 8 is rotated one step to the left, the input position moves back to the previous position (to the left on the display portion 6).

For example, if entering the phone number “119”, then the operation is performed in the following order: the first preset key 9a is single clicked, the tuning knob 8 is rotated one step to the right, the first preset key 9a is single clicked, the tuning knob 8 is rotated one step to the right, and the third preset key 9c is double clicked. In the case in which the number is changed to “119” after entering the phone number “219”, after entering “9”, if the tuning knob 8 is rotated two steps to the left and the first preset key 9a is single clicked, then the first numeral “1” can be re-entered. The vehicle-mounted acoustic apparatus 1 may also be configured such that the next numeral or symbol can be automatically entered after entering a numeral or symbol without rotating the tuning knob 8 to the right.

A phone number that the user enters by operating the preset keys 9a-f is stored (M7) in the RAM 27 of the control portion 24. When the hands-free key 11 is pressed while in the phone number input mode M7, the vehicle-mounted acoustic apparatus 1 initiates a call. That is to say, the vehicle-mounted acoustic apparatus 1 performs an action to transmit a notification to the mobile phone 50 via the hands-free connection, to direct a call to the entered phone number (M5). Then, in a similar manner to the procedure described previously, the vehicle-mounted acoustic apparatus 1 moves to the hands-free conversation mode M3.

The operations of the control portion 24 when numerals or symbols are entered while in the normal dial mode M2-3 are described next in detail. The basic configuration of the present operation is as follows. Identification of the single clicks and the double clicks of the preset keys 9a-f is performed with reference to first to sixth click flags that correspond to the first to sixth preset keys 9a-f respectively. If a given present key 9a-f is pressed and the corresponding click flag is turned ON, then after a predetermined time has elapsed, the print key 9a-f is judged to have been single clicked, and the numeral that corresponds to the single click of that preset key 9a-f is entered. Furthermore, if the same preset key 9a-f is pressed again within the predetermined time period, then the given preset key is judged to have been double clicked, and the numeral or symbol that corresponds to the double click of that preset key 9a-f is entered. When the numeral or symbol corresponding to the single click or double click of the given preset key 9a-f is entered, the click flag corresponding to that preset key 9a-f is turned off. Furthermore, if a given preset key 9a-f is pressed, then the click flags other than the click flag that corresponds to that preset key 9a-f are turned off, and the number of click flags that are ON is always one or less.

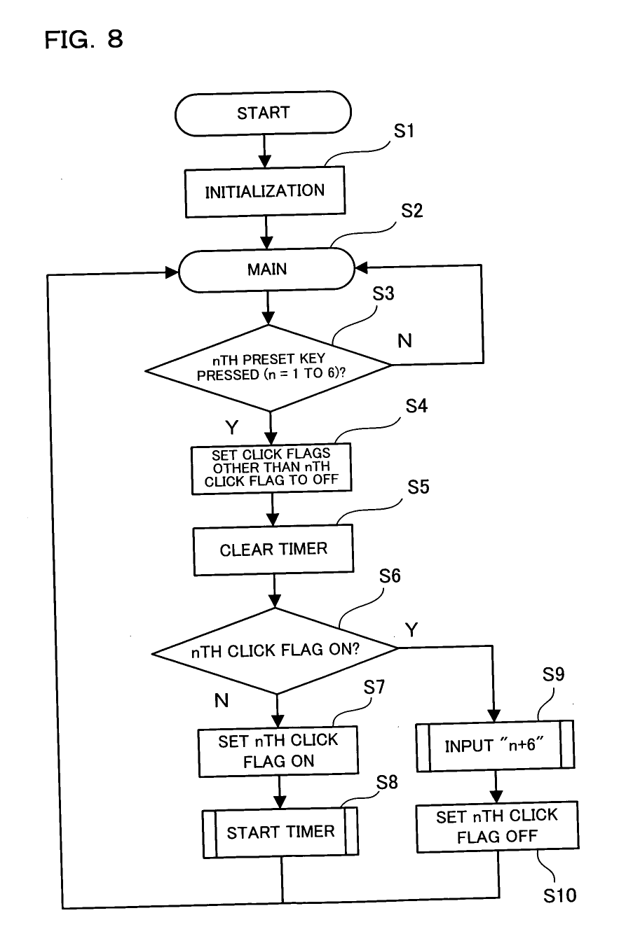

FIG. 8 is a flowchart showing the operations of the control portion 24. A program in which these operations are recorded is stored in the ROM 26 of the control portion 24, and is executed by the control portion 24, or more specifically, the CPU 25. In FIG. 8, and the description below, “n” represents any one numeral from “1” to “6”. Furthermore, if “n” is any numeral from “1” to “3”, then “n+6” represents the numeral that is the sum of “n” and 6. If “n” is “4”, then it represents “0”, if “n” is “5” then it represents the symbol “*”, and if “n” is “6”, then it represents the symbol “#”.

First, initialization (S1) of the control portion 24 occurs when the vehicle-mounted acoustic apparatus 1 moves to the normal dial mode M2-3. The first to sixth click flags that correspond to the first to sixth preset keys 9a-f respectively are stored in the RAM 27 of the control portion 24, and these flags are initialized in step Si. A timer provided by the CPU 25 of the control portion 24 is also initialized. After step Si, the CPU 25 executes a main routine (S2) that relates to inputs while in the normal dial mode M2-3.

While executing the main routine, the CPU 25 identifies the preset key 9a-f that has been pressed (S3), and when an nth preset key is pressed, the CPU 25 sets the click flags that do not correspond to the nth click flag to OFF (S4). If a preset key other than the nth preset key is pressed before the nth preset key, and the click flag corresponding to this preset key is turned ON, then this click flag is turned off in step S4. If no preset key 9a-f is pressed, then the control portion 24 waits for an input (S2).

After step S4, an operation is performed to clear the timer of the CPU 25 (S5). The timer, which is started in step S8 described later, is cleared in step S5. After step S5, the CPU 25 determines whether or not the nth click flag is ON (S6). If the nth click flag is OFF during step S6, then an operation is performed to turn the nth click flag ON (S7), and the timer of the CPU 25 is started (S8). The control portion 24 then starts waiting for an input (S2). If the nth click flag is ON in step S6, then the CPU 25 performs the operation to enter the numeral or symbol corresponding to the double click of the nth preset key (that is stored in the RAM 27) (S9). The nth click flag is then turned OFF (S10), and the control portion 24 waits for an input (S2).

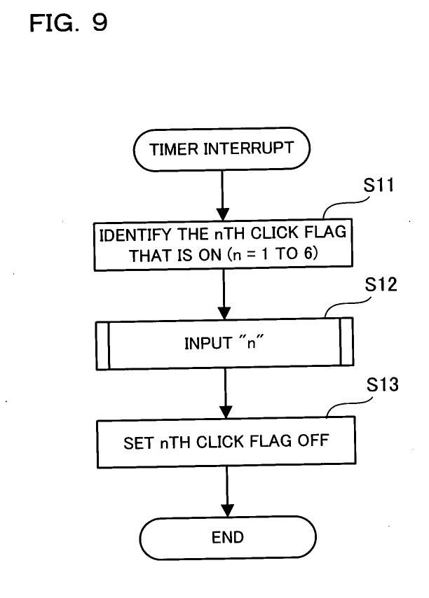

If a predetermined time period passes after the timer of the CPU 25 is started in step S8 without a preset key 9a-f being pressed, then the CPU 25 temporarily stops the main routine, and performs the timer interrupt process. FIG. 9 is a flowchart showing the timer interrupt process. The CPU 25 identifies the click flag that is ON (S11), and enters the numeral that corresponds to the single click of the preset key 9a-f corresponding to that click flag (S12). The click flag that was ON is then turned OFF (S13) and the timer interrupt process ends.

The above-noted operation of the control portion 24 is described using specific examples. The case in which “1” is entered by single clicking the first preset key 9a is described first. The main routine is executed (S2), then when the CPU 25 identifies that the first preset key 9a has been pressed (S3), the click flags other than the first click flag are turned off (S4). For example, if the sixth preset key 9f is pressed before the first preset key 9a is pressed, and step S7 is executed to turn the sixth click flag ON, then the sixth click flag is turned OFF in step S4.

If the timer of the CPU 25 is cleared (S5) after which the first click flag is turned OFF, then the first click flag is turned ON (S6 and S7). The timer of the CPU 25 is then started (S8). If the first preset key 9a is not pressed again within a predetermined time interval after the timer is started, then the timer interrupt process shown in FIG. 9 commences, and “1” is entered (S11 and S12) because the first click flag is ON. After this, the first click flag is turned OFF (S13), and the control portion 24 returns to waiting for an input (S2).

If the first preset key 9a is double clicked and “7” is entered, then the first preset key 9a is judged to have been pressed again within the predetermined time period after starting the timer (S3). The click flags other than the first click flag are then turned OFF (S4). The timer of the CPU 25 is cleared (S5), after which the first click flag is ON, and thus “7” is entered (S9). After this, the first click flag is turned off (S10), and the control portion 24 returns to waiting for an input (S2).

If, instead of the first preset key 9a, the sixth preset key 9f is pressed within the predetermined time period after starting the timer (S3), then the timer interrupt process is not started, and step S4 is executed. The first click flag is switched from ON to OFF in step S4, and the timer is cleared (S5). Since the sixth click flag is OFF, the sixth click flag is turned ON next (S6 and S7). If the timer is then started (S8) and the sixth preset key 9f is pressed again within the predetermined time period after starting the timer (S3), then “#” is entered (S9) after passing through steps S4 to S6. If the sixth preset key 9f is not pressed within the predetermined time period after starting the timer, then the timer interrupt process is started. In this case, “6” is entered (S11 and S12) because the sixth click flag is ON.

In the vehicle-mounted acoustic apparatus 1 of the present invention, it is possible to enter either two numerals, or a numeral and a symbol, with a single preset key 9a-f, by the operations given above. More specifically, a total of 12 numbers and symbols may be input using the six preset keys 9a-f.

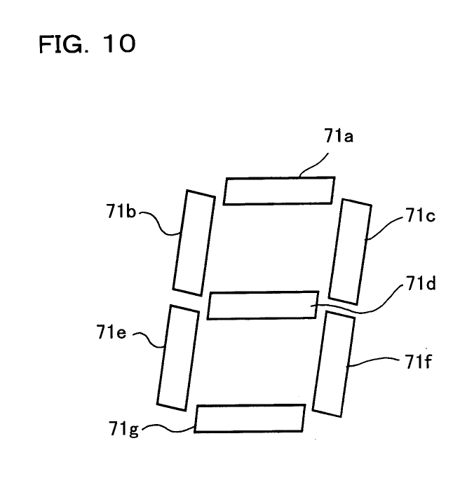

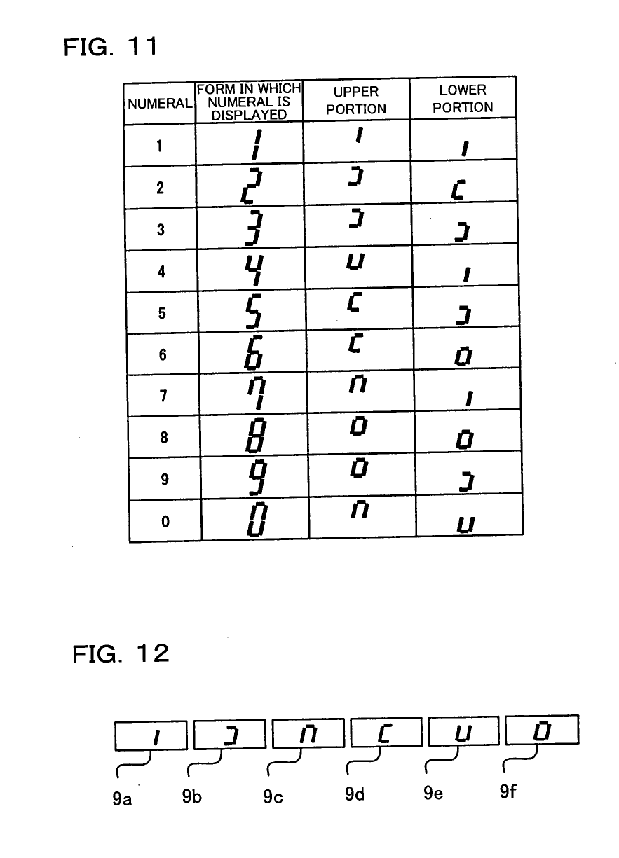

A second embodiment of the vehicle mounted acoustic apparatus 1 of the present invention is described next. The vehicle-mounted acoustic apparatus 1 of the second embodiment has a method for entering numerals in the normal dial mode M2-3 that differs to the previous embodiment. A seven segment LCD is used as the display portion 6 of the vehicle-mounted acoustic apparatus 1, and segment groups that are constituted by seven segments 71a-g arranged as shown in FIG. 10 are aligned in a longitudinal direction as the display portion 6 to provide sufficient numbers to display a phone number. The form in which the numerals “0” to “9” are displayed by the segment group 71a-g is as shown in the second column of the table that is shown as FIG. 11. The fact that should be noted here is that the displayed form of the numerals may be obtained by combining the upper portion shown in the third column of FIG. 11 with the lower portion shown in the fourth column. Here, the middle segment 71d of the segment group 71a-g shown in FIG. 10 may be duplicated in the upper and lower levels.

Moreover, if attention is given to the third and fourth columns of FIG. 11, it can be seen that the upper portion and lower portion of the numerals correspond to any one of six display patterns (see FIG. 12). Consequently, in the second embodiment of the present invention, the vehicle-mounted acoustic apparatus 1 is constituted such that one of these six display patterns is uniquely attributed to each of the six preset keys 9a-f, and the upper portion or lower portion of a numeral is entered by pressing the given preset key 9a-f. Thus, in the second embodiment, a single numeral is represented by entering a combination of an upper portion and a lower portion, and numerals may be entered into the vehicle-mounted acoustic apparatus 1 by operating the preset keys 9a-f.

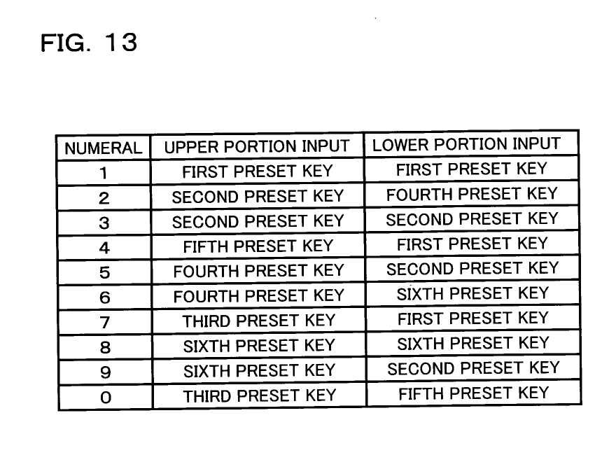

FIG. 12 is a front view of the preset keys 9a-f of the vehicle-mounted acoustic apparatus 1 of the second embodiment. The display pattern that is entered into the vehicle-mounted acoustic apparatus 1 when the preset keys 9a-f are pressed is inscribed on the preset keys 9a-f. FIG. 13 is a table showing the combinations of the preset keys 9a-f to be pressed to enter the numerals “0” to “9”. The user selects the preset key 9a-f to enter the upper portion of the numeral that it is desired to enter into the vehicle-mounted acoustic apparatus 1, after which a preset key 9a-f is selected to enter the numeral's lower portion. When the upper portion or lower portion of the numeral is entered into the vehicle-mounted acoustic apparatus 1, the entered upper portion or lower portion is displayed in the segment group 71a-g. That is, the user inputs the numeral into the vehicle-mounted acoustic apparatus 1 by selecting and pressing the preset keys 9a-f such that the desired numeral is displayed in the segment group 71a-g.

For a given numeral of a phone number (for example, the second numeral), when the upper portion of the numeral is entered into the vehicle-mounted acoustic apparatus 1, the vehicle-mounted acoustic apparatus 1 enters a lower portion input mode, in which it is possible to input the lower portion of the numeral. Then, when the lower portion is input while in the lower portion input mode, the vehicle-mounted acoustic apparatus 1 enters an upper portion input mode, in which the upper portion of the next numeral (for example, the third numeral) may be input. For example, if the number “110” is to be entered, the first preset key 9a is pressed four times in a row, then the third preset key 9c is pressed, and lastly, the fifth preset key 9e is pressed.

After a given preset key 9a-f is pressed while in the upper portion input mode, and the display pattern corresponding to the given preset key 9a-f is entered as the upper portion into the vehicle-mounted acoustic apparatus 1, it is possible that a preset key 9a-f corresponding to a display pattern that cannot display a numeral in combination with the given display pattern is pressed while in the lower portion input mode. In this case, the input of the upper portion is changed to the display pattern corresponding to the preset key 9a-f that is pressed second. For example, if the first preset key 9a is pressed while in the upper portion input mode and a given segment portion 71a-g is displayed as shown in the second row, third column of FIG. 11, then if the sixth preset key 9f is pressed while in the lower portion input mode, the input of the upper portion is changed to the display pattern corresponding to the sixth preset key 9f, and the segment group 71a-g is displayed as shown in the ninth row, third column of FIG. 11. Furthermore, as shown in FIG. 13, the display pattern that has been attributed to the third preset key 9c does not correspond to the lower portion of any numeral, and so the third preset key 9c cannot be used when entering the lower portion. Thus, the vehicle-mounted acoustic apparatus 1 may be configured so as to return to the upper portion input mode of the previous numeral when the third preset key 9c is pressed while in the lower portion input mode.

The control portion 24 is operated as described below to input numerals using the preset keys 9a-f according to the second embodiment. An outline of the present operation is as follows. The first to the sixth click flags are set within the control portion 24 to correspond to the first to sixth preset keys 9a-f respectively. In the upper portion input mode, all the click flags are OFF, and when a preset key 9a-f is pressed while in the upper portion input mode, the click flag that corresponds to that preset key 9a-f is turned ON. The display pattern that corresponds to that preset key 9a-f is then input into (the control portion 24 of) the vehicle-mounted acoustic apparatus 1 as the upper portion, and the control portion 24 moves the vehicle-mounted acoustic apparatus 1 to the lower portion input mode.

When the preset key 9a-f is pressed while in the lower portion input mode, the numeral that is displayed, which is a combination of the display pattern of the preset key 9a-f that corresponds to the click flag that is ON, and the display pattern of the preset key 9a-f that was pressed in the lower portion input mode, is entered into the vehicle-mounted acoustic apparatus 1. More specifically, the CPU 25 of the control portion 24 judges the numeral that is displayed by this combination, and stores it in the RAM 27 of the control portion 24. After the numeral is input into the vehicle-mounted acoustic apparatus 1, the control portion 24 sets all the click flags to OFF, and moves the vehicle-mounted acoustic apparatus 1 to the upper portion input mode for the next numeral.

If a preset key 9a-f that corresponds to display patterns that do not represent any numeral if combined with a display pattern that is entered in the upper portion is pressed while in the lower portion input mode, then all the click flags are turned off, and further, the click flag that corresponds to the preset key 9a-f that was pressed is turned ON. Then, the control portion 24 changes the input of the upper portion to the display pattern of the preset key 9a-f that was pressed, and moves the vehicle-mounted acoustic apparatus 1 to the lower portion input mode.

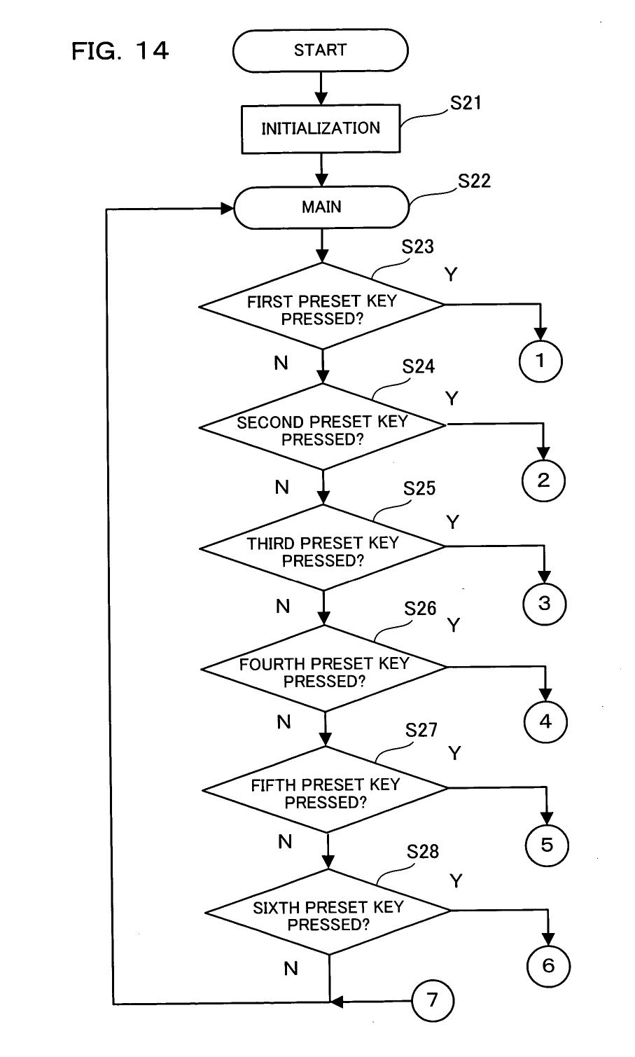

FIG. 14 to FIG. 20 are flowcharts showing the present operation. A program in which this operation is recorded is stored in the ROM 26 of the control portion 24, and is executed by the control portion 24, more specifically by the CPU 25. First, when the vehicle-mounted acoustic apparatus 1 moves to the normal dial mode M2-3, the control portion 24 is initialized (S21). The RAM 27 of the control portion 24 stores the first to sixth click flags that correspond to the respective first to sixth preset keys 9a-f, and these click flags are initialized in step S21. After step S21, the CPU 25 of the control portion 24 executes (S22) the main routine relating to inputs during the normal dial mode M2-3.

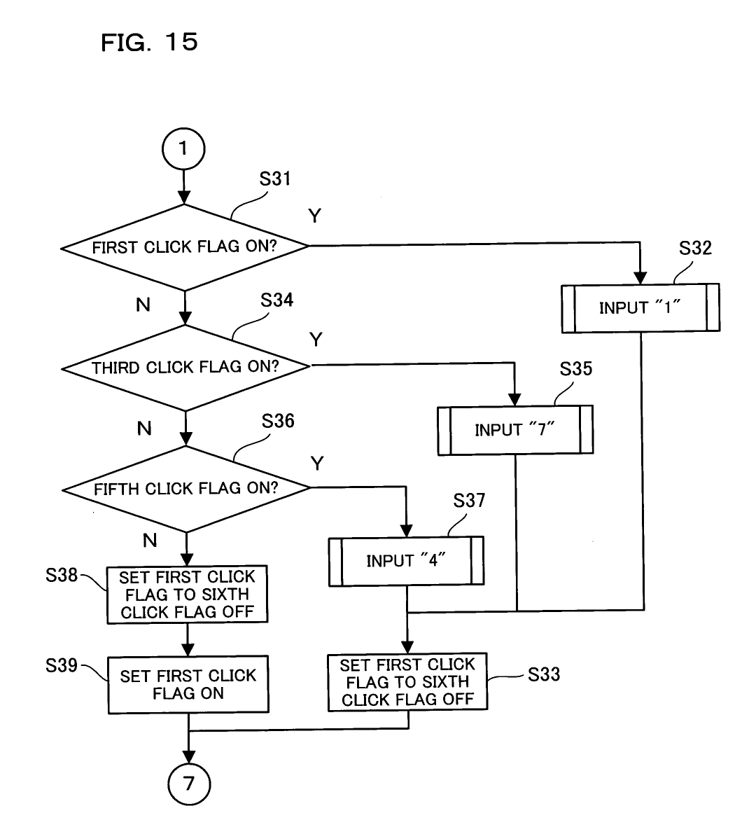

While executing the main routine, the CPU 25 identifies the preset key 9a-f that was pressed (S23 to S28). If the first preset key 9a is judged to have been pressed (S23), then the process shown in FIG. 15 is performed. First, the CPU 25 of the control portion 24 judges whether or not the first click flag is ON (S31). If the first click flag is ON, that is to say, if the first preset key 9a has already been pressed and the upper portion input (see the third line, second row of FIG. 11), then the display pattern of the first preset key 9a is entered as the lower portion, and the numeral “1” is input (S32). Then, all the click flags are turned OFF, and the control portion 24 moves the vehicle-mounted acoustic apparatus 1 to the upper portion input mode (S33). After this, the control portion 24 returns to waiting for input (S22).

If the first click flag is OFF in step S31, then the CPU 25 judges whether or not the third click flag is ON (S34). If the third click flag is ON, that is, if the third preset key 9c has already been pressed and input into the upper portion (see line 8, column 3 of FIG. 11), then the display pattern of the first preset key 9a is input as the lower portion, and further, the control portion 24 inputs the numeral “7” (S35). After this, step S33 is performed, and the control portion 24 returns to waiting for input (S22).

If the third click flag is OFF in step S34, then the CPU 25 judges whether or not the fifth click flag is ON (S36). If the fifth click flag is ON, that is, if the fifth preset key 9e has already been pressed and input into the upper portion (see line 5, column 3 of FIG. 11), then the display pattern of the first preset key 9a is input as the lower portion, and further, the control portion 24 inputs the numeral “4” (S37). After this, step S33 is performed, and the control portion 24 returns to waiting for input (S22). If the fifth click flag is OFF in step S36, then after turning all the click flags OFF (S38), the CPU 25 turns the first click flag ON (S39). Then, the control portion 24 returns to waiting for input (S22).

In the upper portion input mode, that is to say, when all the click flags are OFF, step S39 is executed via steps S31, S34, S36 and S38 when the first preset key 9a is pressed (S23). In this case, in step S39, the CPU 25 turns the first click flag ON, inputs the display pattern of the first preset key 9a as the upper portion, and moves the vehicle-mounted acoustic apparatus 1 to the lower portion input mode.

In a state in which the upper portions are input by pressing the second, fourth or sixth preset keys 9b, 9d or 9f, if the first preset key 9a is pressed (S23), then step S38 is executed via steps S31, S34 and S36. Even if the display patterns of the second, fourth or sixth preset keys 9b, 9d or 9f are set to the upper portion, and if the display pattern of the first preset key 9a is set to the lower portion, the combination of these patterns does not represent any numeral. Therefore, in step S38, the control portion 24 turns the second, fourth or sixth click flag OFF, and erases the input of the upper portion. The control portion 24 also returns the vehicle-mounted acoustic apparatus 1 to the upper portion input mode. Then, in step S39, if the first click flag is turned ON, then the control portion 24 enters the display pattern of the first preset key 9a into the upper portion, and moves the vehicle-mounted acoustic apparatus 1 to the lower portion input mode.

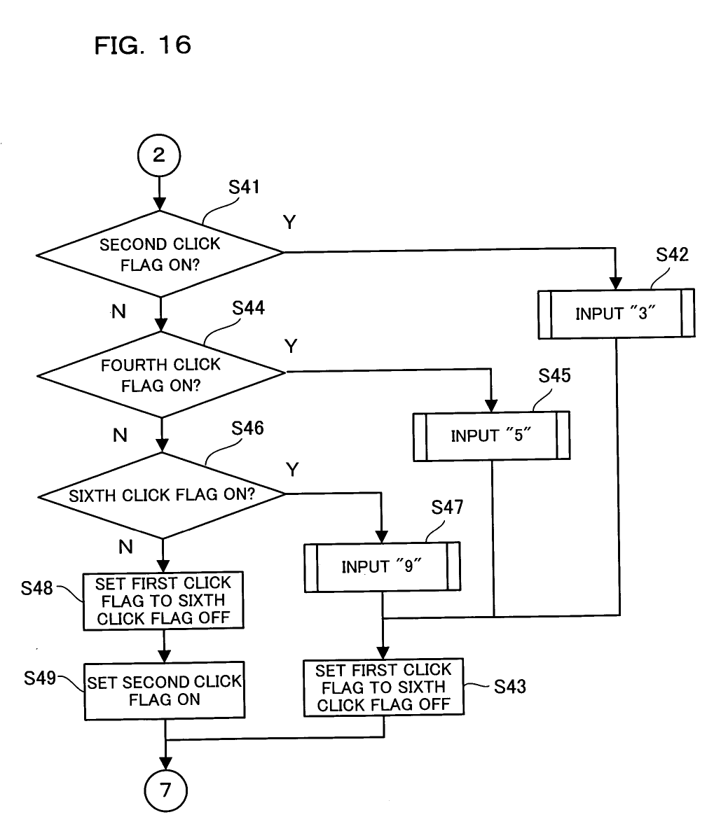

When executing the main routine, if the second preset key 9b is judged to have been pressed (S24), then the process shown in FIG. 16 is carried out. The CPU 25 judges whether or not the second click flag is ON (S41). If the second click flag is judged to be ON in step S41, then the control portion 24 inputs the numeral “3” (S42). If the second click flag is judged to be OFF in step S41, then the CPU 25 judges whether the fourth click flag is ON or not (S44). If the fourth click flag is judged to be ON in step S44, then the control portion 24 inputs the numeral “5” (S45). If the fourth click flag is judged to be OFF in step S44, the CPU 25 judges whether or not the sixth click flag is ON (S46). If the sixth click flag is judged to be ON in step S46, then the control portion 24 enters the numeral “9” (S47). If the sixth click flag is judged to be OFF in step S46, then all the click flags are turned OFF (S48). Then, the second click flag is turned ON (S49), and the control portion 24 returns to waiting for input (S22). Furthermore, all the click flags are turned OFF after steps S42, S45 and S47 (S43). The control portion 24 then returns to waiting for input S22.

The processes constituting steps S41 to S49 shown in FIG. 16 are the same as the processes constituting steps S31 to S39 shown in FIG. 15. Thus, a description of items relating to steps S41 to S49 that can be inferred from, for example, the description relating to FIG. 15 is hereby omitted.

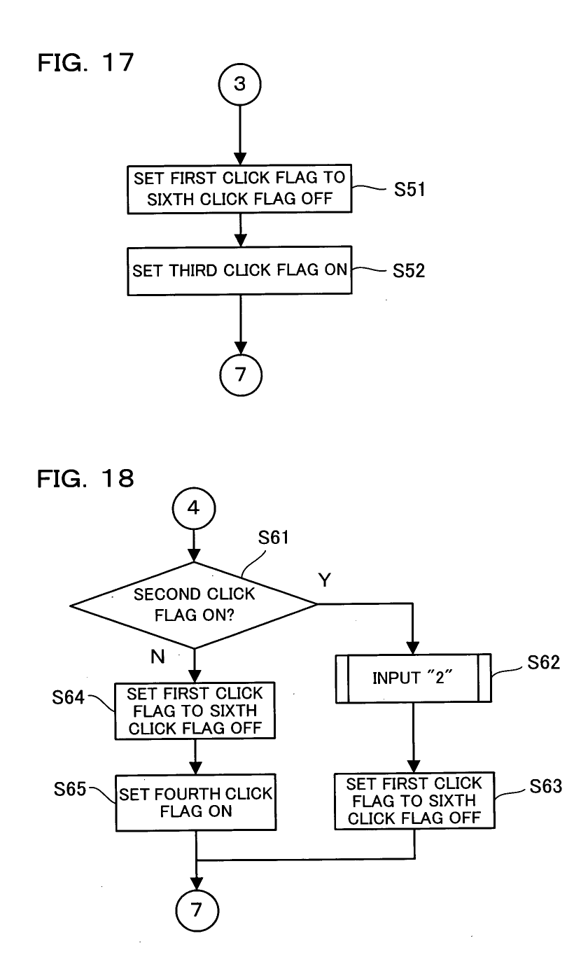

When executing the main routine, if the third preset key 9c is judged to have been pressed (S25), then the process shown in FIG. 17 is performed. As can be understood from FIG. 11 or FIG. 13, the display pattern corresponding to the third preset key 9c is only valid for input to the upper portion. Consequently, when the third preset key 9c is pressed, all the click flags are turned OFF (S51), and further, the third click flag is turned ON, the display pattern of the third preset key 9c is input as the upper portion, and the control portion 24 moves the vehicle-mounted acoustic apparatus 1 to the lower portion input mode (S52).

If the third preset key 9c is pressed while there is a click flag that is ON (S25), the click flag is turned OFF in step S51, and the input in the upper portion is erased, and further, the vehicle-mounted acoustic apparatus 1 returns to the upper portion input mode. Then step S52 is performed.

The process shown in FIG. 18 is performed when the fourth preset key 9d is judged to have been pressed while executing the main routine (S26). First, the CPU 25 judges whether or not the second click flag is ON (S61). If the second click flag is judged to be ON in step S61, then the control portion 24 inputs the numeral “2” (S62). All the click flags are then turned OFF (S63). If the second click flag is judged to be OFF in step S61, then all the click flags are turned OFF (S64), after which the fourth click flag is turned ON (S65).

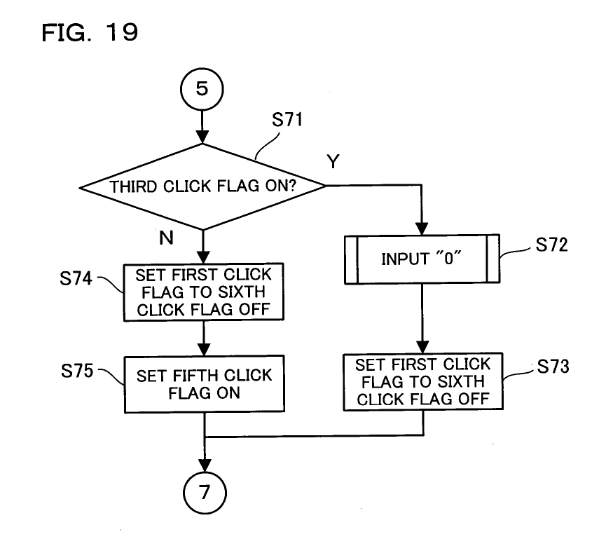

The process shown in FIG. 19 is performed when the fifth preset key 9e is judged to have been pressed while executing the main routine (S27). First, the CPU 25 judges whether or not the third click flag is ON (S71). If the third click flag is judged to be ON in step S71, then the control portion 24 inputs the numeral “0” (S72). All the click flags are then turned OFF (S73). If the third click flag is judged to be OFF in step S71, then all the click flags are turned OFF (S74), after which the fifth click flag is turned ON (S75).

The process constituting steps S61 to S65 shown in FIG. 17 is the same as the process constituting step S33 and steps S36 to S39 shown in FIG. 15. Thus, a description of items relating to steps S61 to S65 that can be inferred from, for example, the description relating to FIG. 15 is hereby omitted. This also applies to steps S71 to S75 shown in FIG. 18.

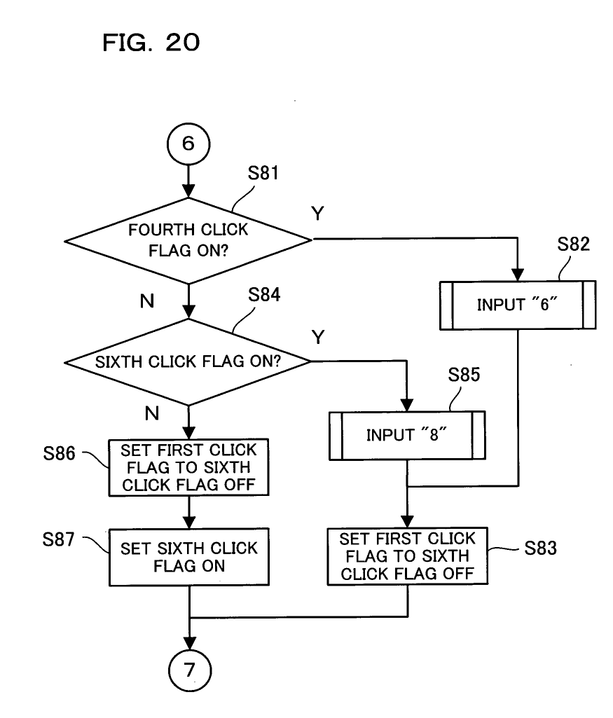

When executing the main routine, the process shown in FIG. 20 is performed when the sixth preset key 9f is determined to have been pressed (S28). First, the CPU 25 judges whether or not the fourth click flag is ON (S81). If the fourth click flag is judged to be ON in step S81, then the control portion 24 inputs the numeral “6” (S82). If the fourth click flag is judged to be OFF in step S81, then the control portion 24 judges whether or not the sixth click flag is ON (S84). If the sixth click flag is judged to be ON in step S84, then the control portion 24 enters the numeral “8” (S85). If the sixth click flag is judged to be OFF in step S84, then all the click flags are turned OFF (S86), after which the sixth click flag is turned ON. Furthermore, after step S82 or step S85, all the click flags are turned OFF (S83).

The process constituting steps S81 to S87 shown in FIG. 20 is the same as the process constituting step S33 to S39 shown in FIG. 15. Thus, a description of items relating to steps S81 to S87 that can be inferred from, for example, the description relating to FIG. 15 is hereby omitted.

As described above, phone numbers may be input in the normal dial mode M2-3, however it is also possible to conclude that operating the preset keys 9a-f to input phone numbers while driving may lead to problems in terms of the safety of the user (particularly the driver). Consequently, in the vehicle-mounted acoustic apparatus 1 of the present embodiment it is possible for the user to store phone numbers that have been input by operating the preset keys 9a-f into the phone number memory 29. After the phone numbers are input in the normal dial mode M2-3, when any of the preset keys 9a-f are pressed and held, the control portion 24 attaches the phone number that is stored in the RAM 27 to the ID number that has the same number as the preset key 9a-f, and stores it in the phone number memory 29. If there is already a phone number recorded in the phone number memory 29 with the same ID number as the number of the preset key 9a-f, then the phone number corresponding to that ID number is substituted in. This operation to record phone numbers is the same as the operation to preset the frequency for receiving radio broadcasts in general vehicle-mounted acoustic apparatuses, and thus is intuitive and easy for users to understand.

The above description of an embodiment is for describing the present invention, and should not be interpreted as limiting or restricting the scope of claims of the invention. Furthermore, it goes without saying that the configuration of the parts of the present invention is not limited to the above embodiment, and that various modifications are possible within the technical scope of the claims.

### INDUSTRIAL APPLICABILITY

The present invention provides mobile phone hands-free conversing means having sufficient operational functions necessary for making calls, wherein free space within the vehicle and holding members and the like are not required.

1. A vehicle-mounted acoustic apparatus that can be connected to a mobile phone; which can receive hands-free conversations from the mobile phone and radio broadcasts; and which comprises a microphone for collecting the sounds of a user, and a speaker for producing the sounds of a radio broadcast or a conversing party, the vehicle-mounted acoustic apparatus being capable of selecting:
a first mode for selecting a phone number that is stored in the mobile phone using a plurality of preset keys that are used to select the frequency of radio broadcasts to be received and for calling the selected phone number with the mobile phone; and
a second mode for selecting a phone number that is stored in the vehicle-mounted acoustic apparatus using the plurality of preset keys and for calling the selected phone number with the mobile phone;
wherein numerals or symbols that constitute a phone number to be stored in the vehicle-mounted acoustic apparatus are input using the plurality of preset keys and the numerals or symbols that are input with one press of the plurality of preset keys differ from those input with two presses.

2. The vehicle-mounted acoustic apparatus according to claim 1,
wherein the plurality of preset keys are associated with a plurality of ID numbers that are stored in the mobile phone and the plurality of ID numbers are uniquely attached to a plurality of phone numbers that are stored in the mobile phone.

3. The vehicle-mounted acoustic apparatus according to claim 1,
wherein the plurality of preset keys are associated with a plurality of ID numbers that are stored in the vehicle-mounted acoustic apparatus and the plurality of ID numbers are uniquely attached to a plurality of phone numbers that are stored in the vehicle-mounted acoustic apparatus.

4. A vehicle-mounted acoustic apparatus according to claim 1 that can be connected to the mobile phone through a short-range wireless connection.

5. A vehicle-mounted acoustic apparatus that can be connected to a mobile phone; which can receive hands-free conversations from the mobile phone and radio broadcasts; and which comprises a microphone for collecting the sounds of a user, and a speaker for producing the sounds of a radio broadcast or a conversing party;
wherein each of a plurality of present keys that are used for selecting the frequency of radio broadcasts to be received is associated with a display pattern that corresponds to an upper portion or a lower portion of a form by which the numerals from “0” to “9” are displayed; and
wherein using the plurality of the preset keys, the numerals that constitute a phone number are input by entering the upper portion and the lower portion of the form by which the numerals are displayed.

6. The vehicle-mounted acoustic apparatus according to claim 5 that comprises a display portion having segment groups, each of the segment groups constituted by seven segments.

7. The vehicle-mounted acoustic apparatus according to claim 5,
wherein the plurality of the preset keys are used for selecting a phone number that is stored in the mobile phone.

8. A vehicle-mounted acoustic apparatus according to claim 5 that can be connected to the mobile phone through a short-range wireless connection.

9. A vehicle-mounted acoustic apparatus that can be connected to a mobile phone; which can receive hands-free conversations from the mobile phone and radio broadcasts; and which comprises a microphone for collecting the sounds of a user, and a speaker for producing the sounds of a radio broadcast or a conversing party, the vehicle-mounted acoustic apparatus being capable of selecting:
a first mode for selecting a phone number that is stored in the mobile phone using a plurality of preset keys that are used to select the frequency of radio broadcasts to be received and for calling the selected phone number with the mobile phone;
a second mode for selecting a phone number that is stored in the vehicle-mounted acoustic apparatus using the plurality of preset keys and for calling the selected phone number with the mobile phone; and
a third mode for inputting the phone number using the plurality of preset keys, and for calling the input number with the mobile phone; and further comprising:
storing means for storing the phone number input in the third mode.

10. The vehicle-mounted acoustic apparatus according to claim 9,
wherein the plurality of preset keys are associated with a plurality of ID numbers that are stored in the mobile phone and the plurality of ID numbers are uniquely attached to a plurality of phone numbers that are stored in the mobile phone.

11. The vehicle-mounted acoustic apparatus according to claim 9,
wherein the plurality of preset keys are associated with a plurality of ID numbers that are stored in the vehicle-mounted acoustic apparatus and the plurality of ID numbers are uniquely attached to a plurality of phone numbers that are stored in the vehicle-mounted acoustic apparatus.

12. The vehicle-mounted acoustic apparatus according to claim 9,
wherein numerals or symbols that constitute a phone number to be stored in the storing means are input using the plurality of preset keys and the numerals or symbols that are input with one press of the plurality of preset keys differ from those input with two presses.

13. The vehicle-mounted acoustic apparatus according to claim 9,
wherein each of the plurality of preset keys is associated with a display pattern that corresponds to an upper portion or a lower portion of a form by which the numerals from “0” to “9” are displayed; and
wherein using the plurality of the preset keys, numerals that constitute a phone number to be stored in the storing means are input by entering the upper portion and the lower portion of the form by which the numerals are displayed.

14. The vehicle-mounted acoustic apparatus according to claim 13 that comprises a display portion having segment groups, each of the segment groups constituted by seven segments.

15. A vehicle-mounted acoustic apparatus according to claim 9 that can be connected to the mobile phone through a short-range wireless connection.
